(19) United States
(12) Patent Application Publication
(10) Pub. No.: US 2019/0275512 A1
(43) Pub. Date: Sep. 12, 2019

(54) SAMPLE CHAMBER

(71) Applicant: ibidi GmbH, Martinsried (DE)

(72) Inventor: Jan Schwarz, Stockdorf (DE)

(21) Appl. No.: 16/297,176

(22) Filed: Mar. 8, 2019

(30) Foreign Application Priority Data
Mar. 9, 2018 (EP) 18160916.5

(51) Int. Cl. B01L 3/00

(52) U.S. Cl. CPC B01L 3/508; B01L 2300/041; B01L 2300/123; B01L 2300/161

(57) ABSTRACT

A sample chamber comprises a first part and a second part connected therewith and a sample reservoir that is delimited by the first part and the second part, wherein the sidewalls and/or the ceiling of the sample reservoir are formed by the first part and the bottom of the sample reservoir is formed by the second part, wherein the bottom of the sample reservoir comprises a planar face that includes a coating, and wherein the coating is formed from an oligomer and/or polymer layer that is cell-rejecting and/or biomolecule-rejecting.

### FIELD OF THE INVENTION

The invention relates to a sample chamber and to a method for fabricating such a sample chamber.

### BACKGROUND OF THE INVENTION

In particular in the field of cell microscopy there are known very different types of sample chambers. Such sample chambers may comprise structures for receiving a sample, for example in the form of microfluidic channels or reservoirs. Examples for such sample chambers are shown in EP 1 886 792 A2, WO 2008/149914 A2, WO 2005/079985 or DE 10148210 A1. Simple and well known forms comprise Petri dishes and multi well plates, as described in DIN EN ISO 24998 or ANSI/SBS 2-2004 for microplates.

WO 2016/050980 A1 describes a method, in which an adhesion pattern is applied on a polymer layer. From WO 03/012077 there is known a method, which prevents cells in solution from adhering to a surface, wherein additionally cell to cell contact is suppressed. MX 2014011008 describes an apparatus for the microstructured application of molecules onto a substrate.

From US 2015/0240115 A1 there is known a method, by which a coating may be applied onto a polymer substrate. U.S. Pat. No. 6,818,018 B1 describes a composition and a method for forming hydro gels by a combination of physical and chemical cross-linking processes. US 2014/0322742 A1 describes an apparatus and a method for producing three-dimensional multi cell structures in vitro, wherein at least one such structure is immobilized on a two-dimensional adhesion structure.

From US 2005/0279730 A1 there is known a method for producing cell culture substrates, which allows cells to be precisely adhered upon a base material. WO 02/072797 A2 describes the production of cell culture substrates having improved cell adhesion by irradiating plastic materials with UV radiation. WO 2014/118311 A1 discloses an apparatus that offers a plurality of cell-adhesive patterns on a surface. WO 2005/026313 A1 describes a method and an apparatus for the precise control of the distribution of the adhesion of cells. From WO 2016/069892 A1 there are known microtiter plates, in which the wells have non-adhesive surfaces.

WO 2013/042360 A1 describes a cell culture apparatus that has a cell-rejecting surface. From WO 2014/179196 A1 there is known an apparatus for cell culturing of spheroids, which comprises bowls with rounded bottom and a cell-rejecting coating. U.S. Pat. No. 5,002,582 A describes a method, in which polymers are bonded to surfaces in a covalent manner. From US 2005/0287218 A1 there is known a biomaterial that is produced by cross-linking a macromolecule. U.S. Pat. No. 4,978,713 A1 discloses a contact lens made of a polymer of a polyvinyl alcohol derivative.

US 2013/018110 A1 describes a method for producing a hydrogel from a hydrophilic polymer. From US 2001/056301 A1 there are known bio medical parts that are produced from macromolecules having a polymer backbone. EP 027405960 A2 discloses a plastic substrate, on which an acrylic coating is photochemically applied. From DE 10149587 A1 there is known a method for producing photoreactively coated polymer membranes. WO 03/093329 A1 discloses a system for the photochemical coating of containers from a thermoplastic polymer.

From WO 2005/040294 there is known an organo-silane based compound for producing a gas barrier layer. WO 2009/091224 A2 describes a method for producing an optical film for a liquid crystal display by means of photochemical cross-linking. From US 2009/226629 A1 there is known a method for producing a display substrate by means of irradiating UV radiation on a photoreactive monomer.

### BRIEF SUMMARY OF THE INVENTION

It is an object of the present invention to provide a sample chamber that enables an improved control of cell growth.

The object is achieved by a sample chamber according to claim 1.

The sample chamber according to the invention comprises a first part and, connected thereto, a second part, as well as a sample reservoir that is defined or delimited by the first part and the second part. According to the invention the sidewalls and/or the ceiling of the sample reservoir are formed by the first part, and the bottom of the sample reservoir is formed by the second part. The bottom of the sample reservoir comprises a planar face having a coating, which is formed from an oligomer and/or polymer layer that is cell-rejecting and/or biomolecule rejecting.

“Cell rejecting and/or biomolecule rejecting” is to be understood such that no adhesion of cells or biomolecules takes place on the oligomer and/or polymer layer. Biomolecules are molecules, which are formed in biochemical processes, in particular in naturally existing processes.

The terms “sidewalls”, “ceiling” and “bottom” refer to the arrangement of the parts in accordance with their intended use.

A planar face is to be understood as a face that does not have any intentionally formed recesses or elevations, such as bowls or cavities of a microtiter plate.

In particular, the coating may be structured. The structuring of the coating is caused by the fact that the coating of the planar face is not fully covered and/or that the surface of the coating is structured, i.e., comprises elevations and/or recesses. Due to the structured coating the fabrication process of the sample chamber may be simplified and may be made more flexible, since an embodiment of the non-covered second part may be adapted to a plurality of applications by appropriate structuring of the coating.

The planar face may at least comprise a predetermined cell adhesion region that is not covered by the oligomer and/or polymer layer. By means of the cell adhesion region the coating is structured. In the cell adhesion region an adhesion of cells is possible. In this case, the cell adhesion region may take the form of a circular area, the area of a polygon, two-dimensional lines or a combination of these elements.

Such a cell adhesion region in the planar face is particularly advantageous for the observation of cells, in particular by means of inverse microscopy through the bottom of the sample chamber. For example, additional undesired reflection or refraction effects will not occur, which would be caused by structuring, as is, for example, present in a microtiter plate. Moreover, a potential impairment of the optical observation through the coating is suppressed.

Furthermore, the planar face may comprise a plurality of cell adhesion regions and/or coating regions. In particular, the arrangement of the cell adhesion regions and/or coating regions may form a regular pattern.

In this way it may, for example, be accomplished that in a sample reservoir a plurality of comparative experiments may be carried out simultaneously, in which cells in the different cell adhesion regions are exposed to the same growth conditions.

Fully defining or bordering the cell adhesion regions by the coating simplifies the determination of the exact growth area, since cell adhesion to the walls of the cell adhesion regions formed by the coating does not occur, meaning, that the growth area is identical to the base area of the cell adhesion region. This is advantageous for applications, in which a specific ratio of the growth area to the volume of the growth medium is desired.

Conventional sample chambers, such as the n-Slide 2-Well Co-Culture of ibidi GmbH, also offer a division of a reservoir into several growth regions, this division, however, is achieved by a three-dimensional structuring of the reservoir bottom. By means of the inventive formation of the plurality of cell adhesion regions by means of the coating, the requirement for a structural change of the reservoir bottom is no longer necessary, thereby simplifying and increasing flexibility of the manufacturing process, since an embodiment of the non-coated second part may be adapted to a plurality of applications by means of an appropriate coating.

The area size of the cell adhesion region may range from 1950 μm² to 315 mm². In particular, the length and/or the width of the cell adhesion regions may be in the range of 50 μm to 20 000 μm. In other cases, the area size of the cell adhesion regions may be in the range of 0.7 μm² to 785 000 μm². In particular, the length and/or the width of the cell adhesion regions may be in the range of 1 μm to 1000 μm. In this manner, isolation of one cell or one cell aggregate, respectively, may be accomplished in one respective cell adhesion region.

The distance between two neighboring cell adhesion regions may v monotonously along one direction. In particular, the shortest distance between the edges of the adjacent cell adhesion regions may change. Alternatively or additionally the sizes of two neighboring cell adhesion regions may monotonously change along this direction. In particular, such changes may have a strictly monotonous form. The terms “monotonous” and “strictly monotonous” are used in this context in their conventional mathematical meaning. It is also possible that the changes behave strictly monotonously in a section wise manner, that is, it may be the case that the distance of neighboring cell adhesion regions along the direction strictly monotonously increases across a first number of adhesion regions, reaches a local minimum and subsequently strictly monotonously increases across a second number of adhesion regions, or vice versa. In this case, the first number and the second number may differ. In other cases, these numbers may be identical. In particular, the first and the second number may be greater than 10.

By such a variation of the distances and/or the difference of the areas of neighboring cell adhesion regions, the sum of the areas of the individual cell adhesion regions, that is, the total area available for the adhesion, may change along the direction. This may be taken advantage of, for instance, so as to control the cell concentration in the sample reservoir along this direction, since the concentration is proportional to the density of the cell adhesion regions. In other words, a gradient of the cell concentration in the sample reservoir along the direction may be generated. In the same way such a gradient may also be generated in further directions that are parallel with respect to the planar face. In particular, the variation in at least two directions may be configured such that a radial cell concentration gradient is obtained, that is, the cell concentration has a maximum or minimum at a certain site, and starting from this site, it decreases or increases, respectively, in any direction that is parallel to the planar face.

The coating may further comprise one or more locally restricted recesses, wherein the bottom of each recess is formed by the coating. In other words, non-coated regions of the bottom will not be exposed by the recesses. In particular, the recesses may be formed such that cells may gather therein and cell aggregates may form. The outline of the recesses may have an oval and/or polygonal shape. In particular, the recesses may have an area ranging from 1950 μm² to 3.15 mm². In particular, the length and/or the width of the recesses may range from 50 μm to 2000 μm.

In such recesses cells may gather, for instance due to gravity. Since the cell-rejecting coating does not provide any possibility for the cell to adhere, that is, for forming contacts with the coating, the formation of cell-cell contacts is promoted. This is advantageous, for instance, for examinations of the cell interaction of different types of cells, or for the examination of cells, which must not adhere due to a potential differentiating stimulus, such as stem cells.

The coating may have a constant layer thickness of less than 1 μm, in particular of less than 500 nm. When comprising recesses formed by a change in layer thickness of the coating layer, thickness outside the recesses a constant layer thickness of up to 2000 μm and within the recesses a layer thickness of less than 1 μm, in particular less than 500 nm may be used. A “constant layer thickness” is to represent the fact that the coating has a substantially constant thickness across the entire coated face. The term “constant layer thickness” however, does not exclude the case that, in particular in the in the edge area of the coating, manufacturing induced variations of the layer thickness may occur. In particular, these variations may be less than 15% of the constant layer thickness.

A layer thickness of less than 1 μm, in particular of less than 500 nm, is advantageous so as to be able to perform, during the intended use, a high-resolution microscopy through the bottom of the sample chamber, since then the optical properties of the bottom are not or only slightly impaired.

The coating may extend along and directly adjacent to a sidewall of the sample reservoir. In this case, the coating may have a width of 1 μm to 10 μm. In this region it may not include any recesses. In other words, the coating may form a barrier between the sidewall and a cell adhesion region or a recess in the coating. Since during the intended use of the sample chamber the cells will collect at the bottom of the sample reservoir due to gravity, such a structuring of the coating results in preventing the cells to collect in the vicinity of the sidewall; therefore also an adhesion to the sidewalls is suppressed without requiring a coating thereof.

The above described structuring may be combined with any of the compositions and properties of the coating described below.

The coating may have hydrophilic properties and/or may be non-toxic. In particular, the coating may be non-cytotoxic. In particular, the coating may have a water contact angle of <50°. Due to the hydrophilic properties, the filling of the sample reservoir with a cell growth solution that typically has aqueous properties, may be improved. An absent toxicity for cells is advantageous, since they will not be damaged by contact with the coating.

The coating may also have amphoteric properties. It may also have hydrophobic properties. In particular, the coating may have a water contact angle of >80°. It may also have super hydrophobic properties. In particular, it may have a water contact angle of >130°.

The water contact angles may be determined by means of a droplet contour analysis, for instance using the Sessile-Drop method. To this end, for instance an optical contact angle (CA) measurement system may be used. This may, for instance, be a part from the OCA series including SCA20 software of the company Data Physics, or a similar part.

The coating may comprise hydrophilic oligomers and/or polymers. In particular, it may comprise or consist of polyethers and/or polyols and/or polyamides and/or polymethacrylates and/or poly(hydroxymethyl)methacrylates and/or polysaccharides and/or poly amines and/or polypeptides or combinations thereof. The polymers may be part of linear or branched hydrophilic block polymers. Hydrophilic block polymers may in particular be polyoxamers or Polyoximines. In particular, the coating may comprise polyvinyl alcohol (PVA). In particular, the coating may be formed of PVA.

The coating may also comprise amphoteric oligomers and/or polymers. In particular, it may comprise or consist of betaines, acralamides, N-isopropyl acrylamides, methacrylates, sulfo ethyl methacrylates, sulfo propyl methacrylates, itacon acid, tri methyl ammonium chloride or combinations thereof.

The coating may further comprise hydrophobic oligomers and/or polymers. In particular, it may comprise or consist of saturated or non-saturated alkane chains having a chain length of more than three carbon atoms. Alternatively or additionally it may comprise fluorinated saturated or non-saturated alkane chains having a chain length of more than three carbon atoms, and/or branched or branch including saturated or non-saturated alkane chains having a chain length of more than three carbon atoms.

The coating may comprise one or more of the above-referenced materials. It may consist of the same material in any of the coated regions. It may, however, also consist of different materials in different regions.

The coating may be provided as a single layer, multilayer or cross-linked gel coating. In this context, a cross linked gel coating is to be understood as a multilayer coating, in which additionally the individual layers are cross-linked to each other.

The coating may be bonded to the second part in a covalent manner or may be adsorbed on the second part. In this case, adsorption is to be understood as a non-specific non-covalent bonding of the coating to the surface. Non-covalent bonds in particular include ionic bonds, hydrogen bonds, hydrophobic interaction bonds, coordination bonds and Van-der-Waals bonds.

The surface of the coating may further comprise, in predetermined regions, molecules and/or oligomers and/or polymers, at which cell adhesion is possible. These molecules and/or oligomers and/or polymers are collectively denoted by the term “functional molecules” in the following and the regions are denoted as “functionalized regions”. The functionalization, i.e. the provision of the functional molecules, may be accomplished by wet-chemical or photochemical treatment of the coating.

In order to bond the functional molecules in the regions to be functionalized, the coating may comprise within the regions hetero atoms or reactive carbon compounds. In particular, the hetero atoms may be oxygen (O), nitrogen (N) or sulfur (S). In particular, the hetero atoms may be present in hydroxyl groups (R—OH), ethers (R—O—R), carbonyl groups (HC═OR), carboxyl groups (R—COOH), esters (R—COO—R), epoxies, thiols (R—SH), thio ethers (R—S—R), amines (R—NR₂), cyanates, iso thiocynates, N-hydroxy succinimid (NHS)-esters, sulfo-NHS-esters, maleimide- or sulfo maleimide esters. Reactive carbon compounds may be terminal or strained alkines, terminal or strained alkenes or alkenes in Michael-systems. In particular, the coating may comprise in the regions to be functionalized terminal or strained alkines. The bond of the hetero atoms or reactive carbon compounds, in particular the terminal or strained alkines, to the coating may in particular be generated by photochemical processes.

In particular, the functionalized regions may be functionalized for specific reactions. For example, the regions may be functionalized so as to bond proteins. The regions may also be functionalized for orthogonal, in particular bio orthogonal bonds. In this context, an orthogonal reaction is to be understood as a reaction, in which side reactions do not occur in the physiological environment. In a bio orthogonal reaction no side reactions affecting the interaction of cells with biomolecules and other cells occur. Bio orthogonal bonds are therefore advantageous for cell bonding to the coating.

Functional molecules for bonding proteins may comprise amine reactive groups, which comprise iso thio cyanates, isocyanates, acyl azides, N-hydroxy succinimid (NHS) esters, sulfonyl chlorides, tosyl esters, aldehydes or glyoxales, epoxy and oxiranes, carbonates, imido esters, carbodiimides, anhydrides, fluorophenyl esters and hydroxy methyl phosphin derivatives. Functional molecules for bonding proteins may also comprise thiol-reactive groups, which comprise haloacetyl and alkyl halogenides, maleimides, aziridines, acryloyl derivatives, acrylic reagents, thiol-disulfide-exchange reagents and vinyl sulfon derivatives. Functional molecules for bonding proteins may also comprise hydroxyl-reactive groups, which comprise epoxy and oxiranes, N,N′-carbonyl diimidazoles, N,N′-disuccinimidyl carbonates, N-hydroxy succinimidyl chloroformates, alkyl halogenides, and isocyanates. Functional molecules for bonding proteins may also comprise carboxyl-reactive groups, which comprise carbodiimide, N,N′-carbonyl diimidazoles, diazoalkanes and other diazoacetyl compounds. In particular, the coating may comprise aziridines and/or NHS and/or Sulfo-NHS in the functionalized regions.

Functional molecules for an orthogonal, in particular a bio orthogonal, bond may comprise terminal or strained alkenes, terminal or strained alkines, carboxyl groups (COOH), terminal primary or secondary amines, or thiols. The functional molecules may in particular comprise groups, which are capable of reacting via cycloaddition reactions. In particular, the functional molecules may be terminal or strained alkines.

The orthogonal bonds may be formed via the mentioned cycloaddition reactions. In particular, a functional molecule that is bonded on the coating may form, by means of such a cycloaddition reaction, a molecule or protein to be immobilized, an orthogonal, in particular a bio orthogonal, bond. Such cycloaddition reactions may be Diels-Alder reactions, copper and copper-free azide alkyne “click reactions”, radical additions such as thiol reactions or Michael additions.

Functional molecules for an orthogonal photochemically initiated bond may comprise groups, which include arylazides and/or halogenated arylazides, benzophenones and/or benzophenone derivatives, anthraquinones and/or anthraquinone derivatives, diazo compounds, diaziirine derivatives, or psoralene compounds.

By means of such a functionalization it is possible to precisely control cell adhesion on the coating without interfering with cell-cell interactions or the interactions of cells with biomolecules.

In particular, in regions functionalized for protein bonds, antibodies may be bound to the coating. In particular, these may be single domain antibodies composed of a single monomeric domain of an antibody. Such single domain antibodies are also known under the name “nanobodies”. This is advantageous, since such antibodies are particularly stable against denaturation, in particular upon drying.

The functional molecules may also exhibit thermally responsive properties. In particular, the adhesion of cells to the functional molecules may be reversed upon a change of the environmental temperature. This allows, for instance, for gentle release operations for sensitive cell types.

Furthermore, in the sample chamber, a natural or synthetic hydrogel may be arranged, in which cells may be embedded. In particular, the hydrogel is arranged on the bottom of the sample reservoir. In this case, the hydrogel may cover any covered and non-covered regions of the bottom. In this case, the inventive coating is advantageous, since it suppresses migration of cells along the bottom, thereby supporting three-dimensional migration of cells in the hydrogel.

The sample reservoir may comprise an opening and/or a cavity, wherein the opening and/or the cavity is formed by a throughgoing opening and/or a recess in the first part.

In particular, the sample reservoir is a portion of the sample chamber that is suited for receiving a liquid. In this case, it may be a reservoir that is open at the top or it may be a cavity. In particular, such a cavity may comprise an opening, through which the liquid may be filled into the reservoir.

The sample chamber itself may be provided in different geometries and shapes. In one embodiment the sample chamber comprises a second part in the form of a planar bottom plate that is connected to the first part. The first part may comprise a recess in the form of a cavity. In this case, the cavity may have the shape of a cylinder or a cuboid. Moreover, the first part may have a throughgoing opening. The opening may have an oval or polygonal shape. The sample chamber may then have the shape of a reservoir that is open at the top and includes an oval or polygonal base area. The shape of the recess or of the throughgoing opening is, however, not restricted to these geometric shapes.

Also, the first part may have the shape of a cover plate. The cover plate may have a recess, wherein in combination with the bottom plate a sample reservoir is formed by the recess in the cover plate. The shape of the sample reservoir may be determined by the geometry of the recess in the cover plate. For example, a sample reservoir having the shape of a channel-like cavity may be formed by a groove in the cover plate. A sample and/or a liquid to be examined may be inserted into the sample reservoir. The sample chamber may be used for chemical and/or biological examinations of chemical and/or biological samples. For example, living cells, proteins, DNA, viruses, and the like may be used as samples.

The second part may be flat element. The flat element may have a substantially constant thickness of 50 to 250 μm, preferably 100 to 200 μm. In particular, the second part may be a plate, a foil or a membrane. Such a design of the second part advantageously enables the application of inverse microscopy.

The height of the sample reservoir may be constant along the channel. It may also, however, change monotonously along the channel. In this case, it is, for instance, possible to perform flow measurements, in which a gradient of the shear stress acting on adhering cells exists along the channel. In particular in combination with a structure of the coating as described above that allows a cell concentration gradient, it may be ensured that the local ratio of the growth area to the volume of the sample reservoir along the channel structure remains substantially constant. In this case, the term “local” refers to a region of the sample reservoir that extends along the channel with a length that is small compared to the total length of the channel.

The sample chamber may comprise a plurality of sample reservoirs. In particular, the plurality of sample reservoirs may have be in fluid communication or they may be separated from each other.

Moreover, the second part may comprise one or more elevations and/or recesses. In particular, the elevations and/or recesses may be arranged at the bottom of the sample reservoir. The elevations and/or recesses may be covered by the oligomer and/or polymer layer. For example, in this manner cell-rejecting “flow traps” may be formed. For example, such elements may restrict the flow of cells through the sample reservoir during flow experiments. By means of the coating, it may be guaranteed that during the intended use, cell adhesion to the flow traps cannot occur.

The first part and/or the second part may be formed as injection moulded parts or may be composed of several plastic parts. They may also be formed in an extrusion procedure. In particular, the several plastic parts may differ in shape and/or material.

Possible plastics are, for example, COC (cyclo-olefin-copolymer), COP (cyclo-olefin-polymer), PE (polyethylen), PS (polystyrol), PC (polycarbonat) or PMMA (polymethyl methacrylate). In particular, the plastic may be COC and/or COP. The plastic may comprise an elastomer. The elastomer may comprise a silicone, in particular polydimethyl siloxane, PDMS. The second part may also comprise a glass. Moreover, the second part may comprise a super hydrophobic plastic, for example a fluorinated polymer. A fluorinated polymer may, for instance, comprise polypentafluorostyrol or block polymers thereof.

The first part and/or the second part may have a predetermined self fluorescence, which in particular may be less or equal to the self fluorescence of COC or COP of any conventional cover glass, and/or may have a predetermined index of refraction.

In particular, the self fluorescence may be less or equal to the self fluorescence of a conventional cover glass, for example a pure white glass of the hydrolytic glass 1, such as Menzel cover glass, in particular with the thickness number 1.5. In particular, the predetermined index of refraction may be >1.2 and/or <1.7. By using such a high-value optically material, microscopy examinations may be performed in an advantageous manner. For example, the birefringence may be so small that DIC (differential interference contrast) is feasible. A small self-fluorescence allows fluorescence measurements to be performed.

The first part and/or the second part may be anti-reflective for a frequency range of electromagnetic radiation. In this manner, the transmission through the first part and/or the second part may be increased, so that single molecule measurements based on fluorescence are viable. For the anti-reflective property, the first part and/or the second part may comprise a further coating. For example, an ITO layer may be arranged on the bottom plate and/or the cover plate. The thickness of the ITO layer may be selected such that the first part and/or the second part are anti-reflective within a frequency range of electromagnetic radiation that is used in microscopy. For example, the thickness of the ITO layer may be λ/2 to 4λ, in order to achieve an anti-reflective behavior, wherein λ indicates the wavelength used. In particular, the wavelength λ may be in the range of 300 nm to 700 nm. In this case, the thickness of the coating may be in the range of 200 nm and 1 μm. In particular, the ITO layer may also be used for temperature control of the sample chamber.

The bottom face of the sample reservoir may have the dimensions of a conventional microscope object carrier, in particular a width of 25.5 mm and a length of 75.5 mm, or may have the dimensions of a multititer plate.

The sample reservoir may have a volume in the range of 10 μl and 200 μl, preferably between 20 μl and 150 μl. In other cases, the sample reservoir may have a larger volume. In particular, it may have a volume between 1 ml and 5 ml. The height of the reservoir may range between 5 μm and 1 mm, preferably between 0.1 mm and 0.5 mm. In other cases, the height of the reservoir may be between 5 mm and 15 mm. The diameter, in particular the maximum diameter, of the reservoir may be in the range between 10 μm and 50 mm, preferably between 1 mm and 35 mm.

Furthermore, the sample chamber may comprise an electrical sensor that is configured for impedance measurements. During such measurements, the cell growth on the sensor surface is examined by means of the resulting impedance variation of the sensor. In particular, the sensor may comprise an electrode that is arranged at the bottom of the sample chamber. In particular in this case, the coating may fully surround the electrode, wherein the electrode surface remains uncoated. In other words, the electrode surface represents a cell adhesion region. This is advantageous, since in this way it may be guaranteed that the cell growth is restricted to the electrode surface.

Sample chambers according to the present invention are specifically suited for functional assays, such as metastasis formation, adhesion and interaction studies, migration, collective migration chemotaxis and collective chemotaxis, perfusion experiments or automatisation at microscopic level.

Furthermore, the present invention provides a method for fabricating a sample chamber, in particular one of the previously described sample chambers, wherein the method comprises the following steps:

providing a first part;

providing a second part;

coating the planar face with an oligomer and/or polymer layer, at which adhesion of cells and/or biomolecules does not take place; and

connecting the first part to the second part so as to form a sample reservoir, which is bordered by the first and second parts, wherein the sidewalls and/or the ceiling of the sample reservoir are formed by the first part and the bottom of the sample reservoir is formed by the second part.

The coating step may be performed prior to or after the connecting step.

The coating may be applied in the form of molecule, oligomer or polymer solution. In particular, solvents may be water and aqueous buffer solutions, methanol, ethanol or propanol, dioxane, dimethyl sulfoxide (DMSO), dimethylformamide (DMF), dichlormethane (DCM) or chloroform. Also mixtures of solvents may be used. In particular, the solvent may be water and/or an aqueous buffer solution.

The molecule, oligomer or polymer solution may be applied by dip, dosing or spray techniques or by means of spin coating. In particular, the coating may be applied by spin coating.

The coating process by means of dip coating may include one or more dipping steps. In this case, the second part may be emerged into the molecule, oligomer or polymer solution during the first dipping step, it may there be incubated and may subsequently be removed. A cross-linking step may follow after each dipping step. In other cases a single cross-linking step may be performed at the end of the coating procedure.

When coating by means of a dosing process, the amount of solvent to be applied may be selected such that only a predetermined surface area is wetted. There, the solution may be incubated and subsequently cross-linked. To this end, the solution may, for instance, be applied onto the second part by means of an industrial jet printer. In this way, coated regions may be fabricated, the size and distance of which are determined by the droplet volume and the nozzle distance of the printer. In this manner, a resolution, that is, a distance between two coated regions, of less than 50 μm may be accomplished for a droplet volume of 2 nL and a nozzle distance of less than or equal to 254 μm.

When coating by means of a spray technique, it is possible to apply one or more layers onto the second part and subsequently induce a cross-linking. In this case, the cross-linking may occur after the application of one layer or after the application of all of the layers.

When coating by means of a spin coating procedure, the solution may be applied with a layer thickness of less than 1000 μm. Such layer thicknesses may be generated by means of plural spin coating steps. In this case, each of the layers may be cross-linked after a single spin coating step or after completing all of the spin coating steps. Also, a layer thickness of less than 1 μm, in particular of less than 500 nm, may be applied. In particular, the layer thickness may be less or equal to 200 nm. In particular, this is possible upon using viscous molecule, oligomer or polymer solutions.

The second part may be activated so as to enhance the bonding of the coating to the surface of the second part. In this context, activating particularly means a change of the surface charge of the second part. Such an activation may comprise an ion plasma treatment. An appropriate ion plasma may, for instance, be generated by means of a low-pressure microwave technique or a corona technique. Suitable ionizing gases may be atmospheric air, pure oxygen or nitrogen. Moreover, activation may comprise exposure to reactive ozone or a treatment with ozone forming UV radiation. Also, the activation may comprise a wet chemical treatment, such as enzymatical oxidation, for example by means of laccase, or oxidation by means of oxidizing mineral acids. The mineral acids may be, for instance, peroxoacid, hydrochloric acid or nitric acid.

Moreover, the activation may comprise photochemical ionization. The photochemical ionization may be performed, in particular by using UV radiation having a wavelength that is less than 254 nm, in particular less than 200 nm.

Activated surfaces may be bonded to the coating, in particular under the influence of a covalent bonding agent. Covalent bonding agents may be, for instance, homo or hetero functional bivalent cross linker in the form Rₓ—Z—Rₓ, wherein Rₓ may be organo-functional groups of the classes amines, alkenes and strained alkenes, such as norbornenes, acrylates, aldehydes, ketales, epoxies, thiols, isothiocyanates, isocyanates or silanes. Z denotes a linker structure that may comprise, for instance, alkene chains of the form (CH₂)ₙ or ethylen glycole chains of the form (OCH₂CH₂)ₘ, wherein 1≤n≤1000.

Hetero functional crosslinkers may take the form Rₓ—Z—R_{y}, wherein R_{y} may be organo-functional groups of the classes of the amines, alkenes and strained alkenes, as for example, norbornenes, acrylates, aldehydes, ketales, epoxies, thiols, isothiocyanates, isocyanates or silanes.

In particular, hetero functional crosslinkers may be silanes. In this case, silanes of the general form Rₓ—(CH₂)ₙ—Si—X₃ are suitable, wherein Rₓ is on organo-functional group, (CH₂)ₙ is an alkane linker and X₃ are hydrolyzable groups. Instead of X₃ silanes may carry the substitution pattern X₂Y or XY₂, wherein Y may not be an hydrolyzable group, for example a methyl or ethyl group. Hydrolyzing or hydrolyzable groups may be alkoxy groups, such as methoxy or ethoxy, or halogen substitutes such as chlorine, bromine or iodine. Organo-functional groups Rₓ may be, in particular, amines, alkenes and strained alkenes, for example, norbornenes, acrylates, aldehydes, ketales, epoxies, thiols, isothiocyanates, isocyanates or silanes. Since the length of the alkane linker affects the hydrophilicity and hydrophobicity, respectively, of the cross linker, linkers of the type (CH₂)ₙ with n<10 are preferred.

The mentioned homo and hetero functional crosslinkers may in particular bond in a photo-catalyzed manner. In this case, type-I photo initiators, for example benzoin derivatives, benzyketales, α-hydroxyketones, α-hydroxyalkyl-phenones, α-amino-acetophenones, α-aminoketones, acylphosphinoxides, metallocenes and/or derivatives thereof, or type-II photo initiators, such as phenylglyoxylates, benzopheneones or thioxanthones and/or derivatives thereof, may be used. In particular, for the photocatalytic boding of the crosslinkers, benzophenones may be used as type-II photo initiators.

In particular, the activation of the second part may be performed selectively. In this way it may be accomplished that the coating bonds to the surface of the second part only in certain regions. The selective activation may be accomplished by using masks during ion plasma or photochemical procedures. In this manner, a pattern of coated regions determined by the structure of the masks may be obtained on the second part.

The solution may also be applied inhomogeneously and may be locally cross-linked. This may be accomplished by the application of a chemical crosslinker by means of a jet printer. This may also be accomplished in a photochemical manner by means of appropriate photo-unstable photo initiators, such as benzoin derivatives, benzilketales, α-hydroxyketones, α-hydroxyalkyl-phenones, α-amino-acetophenones, α-aminoketones, acylphosphinoxides, metallocenes and/or derivatives thereof. Further potential crosslinkers are phenylglyoxylates, benzopheneones or thioxanthones and/or derivatives.

For a photo structuring, the exposure of the solution may be controlled by means of appropriate masks and alternatively or additionally by means of controllable lasers or digitally controllable spatial light modulator (SLM) filters. In this case the resolution of the structuring may be affected by appropriate lens arrangements.

A wet chemical or photochemical local cross-linking of the coating may enable the application of three-dimensional coating structures. In this case, the layer thicknesses may be applied in the thickness of the three-dimensional structure and may be locally cross-linked, as described above. A subsequent filling step may remove non-cross-linked molecules, oligomers or polymers so that only the cross-linked three-dimensional structure remains.

The connecting of the first part to the second part may comprise glueing of the first part to the second part by means of a bonding agent, or it may comprise the chemical or thermal fusing of the first part with the second part. A bonding agent may be, for instance, a resin from the class of epoxies, acrylic acid or isocyanates. It may also belong to the class of the PE, EMMA or EPA based polymer bonding agents. It may also be a cross-linking molecule covalently bonding to the specific coating. This may be a bivalent molecule of the class of the aldehydes, ketales, epoxies, isothiocyanates or isocyanates.

The coating of the second part may further comprise a structuring of the coating by means of shaping stamps. For example, in this case the stamp may be forced into the already cross-linked oligomer and/or polymer layer. It is also viable that, for the shaping, the stamp is placed on the second part during the cross-linking. In particular, the stamp may comprise glass and/or PDMS. This allows a simple application as well as a reuse of the stamp.

The connecting of the first part to the second part may comprise the glueing of the first part to the second part by means of a bonding agent or may comprise the chemical or thermal fusing of the first part and the second part. For example, a bonding agent may be a resin from the class of epoxies, acrylic acids or isocyanates. It may also belong to the class of PE, EMMA or EVA based polymer bonding agents. It may also be a cross-linking molecule covalently bonding to the specific coating. In this case, bivalent molecules of the class of the aldehydes, ketales, epoxies, isothiocyanates or isocyanates may be used.

For the chemical fusing of the two parts, contact surfaces of the two parts may be treated with a solvent and may be connected to each other by pressure. During the thermal fusing, the contact surfaces may be slightly melted at a sufficient surface temperature and may be subsequently connected to each other by pressure.

The connecting of the first and second parts may also be accomplished by means of a polymer connecting both parts. In particular, the connecting polymer may be an elastomer, in particular a silicone. In particular, the polymer may be PDMS.

The connecting of the first part and the second part may occur by means of an adhesion-promoting third part. In particular, the third part may comprise an adhesion-promoting polymer.

Providing the second part may comprise the extrusion of the second part and the coating of the second part may comprise the co-extrusion of a polymer layer together with the second part. In this case, the second part and the polymer layer may be connected to each other directly or by means of adhesion-promotinglayers. This allows an efficient application of the coated second part in one working step. Moreover, appropriate polymers may be co-extruded during the fabrication of the second part. Also, glueing the second part to the coating polymer is an option. In this respect appropriate bonding agents are, for example, epoxy, acrylic or isocyanate based resins, PE, EMMA or EVA based polymer bonding agents.

The method of fabricating the sample chamber pay therefore comprise one or more of the above mentioned features.

### BRIEF DESCRIPTION OF THE SEVERAL VIEWS OF THE DRAWINGS

Further features of the present invention are discussed the following by means of exemplary figures. In the Figures:

FIG. 1 illustrates an embodiment of an inventive sample chamber in exploded view;

FIG. 2 schematically illustrates use cases of sample chambers coated according to the present invention;

FIG. 3 illustrates an embodiment of an inventive sample chamber in exploded view;

FIG. 4 illustrates an embodiment of an inventive sample chamber in exploded view;

FIG. 5 illustrates exemplary forms of inventive recesses;

FIG. 6 illustrates illustrative patterns formed by adhesion structures;

FIG. 7 illustrates the inventive application of a coating by means of a stamp (FIGS. 7a to 7c) as well as potential structures (FIG. 7d to FIG. 7i);

FIG. 8 illustrates embodiments of an inventive sample chamber;

FIG. 9 shows embodiments of an inventive sample chamber;

FIG. 10 illustrates an embodiment of an inventive sample chamber;

FIG. 11 illustrates illustrative patterns formed by adhesion structures;

FIG. 12 illustrates an embodiment of an inventive sample chamber;

FIG. 13 illustrates a is example of an inventive sample chamber;

FIG. 14 shows illustrative patterns formed by adhesion structures;

FIG. 15 illustrates embodiments of an inventive sample chamber; and

FIG. 16 illustrates use cases of inventive sample chambers.

### DETAILED DESCRIPTION OF THE INVENTION

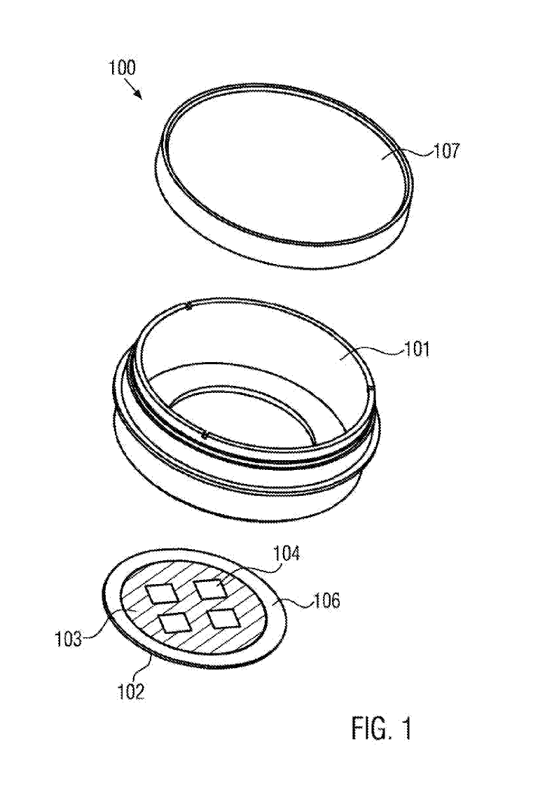

FIG. 1 schematically illustrates the structure of an inventive sample chamber 100 in an exploded illustration. In this case, a first part 101 is shown, having the shape of a circular reservoir with a through-hole or penetrating opening in the bottom. In the embodiment shown, the penetrating opening only comprises a portion of the bottom face of the first part. In other cases, it may comprise the entire bottom face of the first part. Moreover, a second part 102 is illustrated, on which a cell- and biomolecules-rejecting coating 103 is applied. In this case, the coating consists of a PVA layer that has been applied onto the second part by means of spin coating. Subsequently it was locally photochemically cross-linked. The thickness of the illustrated coating may be less than 1 μm and it is substantially constant across the coated region. The coating 103 comprises four adhesion regions 104, which have a rectangular shape.

The two parts may be connected to each other via a connection region 106. The connection may be established by glueing by means of a bonding agent or it may be established by chemical or thermal merging. Also, the parts may be connected by a adhesion-promoting third part (not shown).

In the connected state, the first part 101 and the second part 102 define or delimit a sample reservoir 105, which in this case is formed in the shape of a circular reservoir that is open at the top. By dividing the bottom face into the adhesion regions, the sample reservoir 105 becomes a multi well reservoir. In order to prevent evaporation or contamination the sample reservoir 105 may be sealed by a cap or lid 107.

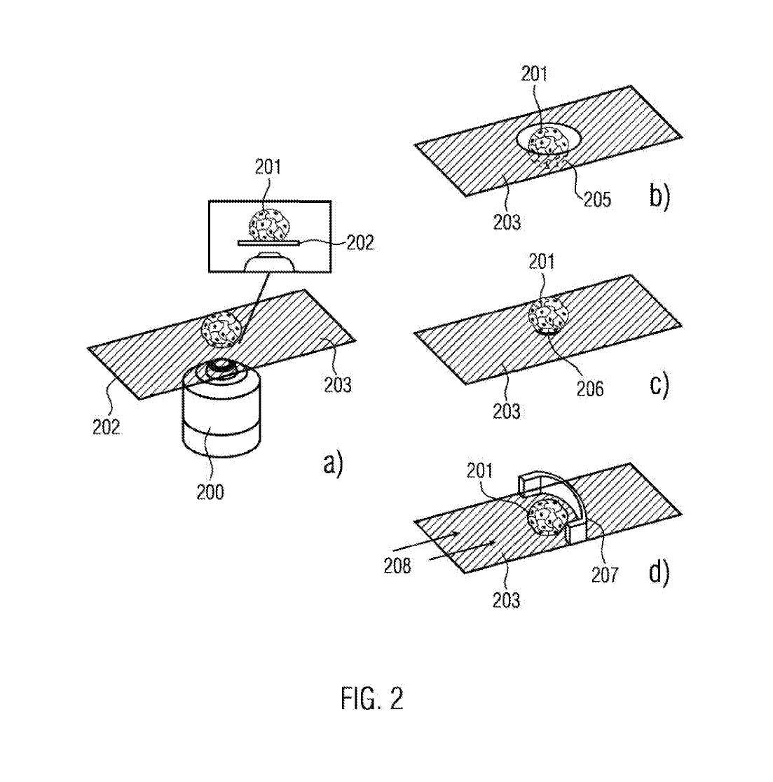

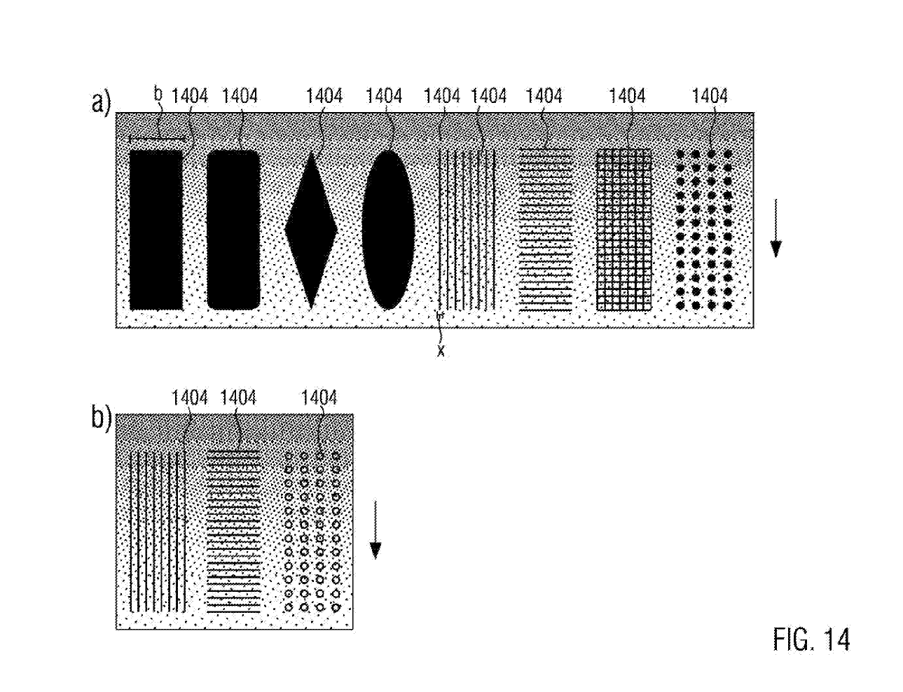

FIG. 2a schematically illustrates the observation of a cell aggregate 201 by means of a microscope 200 in inverse microscopy through the bottom 202 of a sample chamber (not shown). In particular, the bottom 202 is provided with a coating 203 of an oligomer and/or polymer layer, which is cell- and/or biomolecule-rejecting. The coating may correspond to the coating 103 of the embodiment shown in FIG. 14, or may be any one of the coating types specified above. In order to examine cells and cell aggregates with high optical quality by microscopy the observation surface, as shown, has to be planar and also of high optical quality.

FIGS. 2b to 2d schematically illustrate various possibilities as to how to secure a cell aggregate 201 in the observation area. In FIG. 2b this is accomplished by means of a recess 205 within the observation face. In particular, the recess may be formed in the coating. FIG. 2c illustrates the fixation by means of a non-coated planar cell adhesion region 206. In FIG. 2d the fixation by means of a coated flow trap 207 is illustrated. A flow 208 is also indicated.

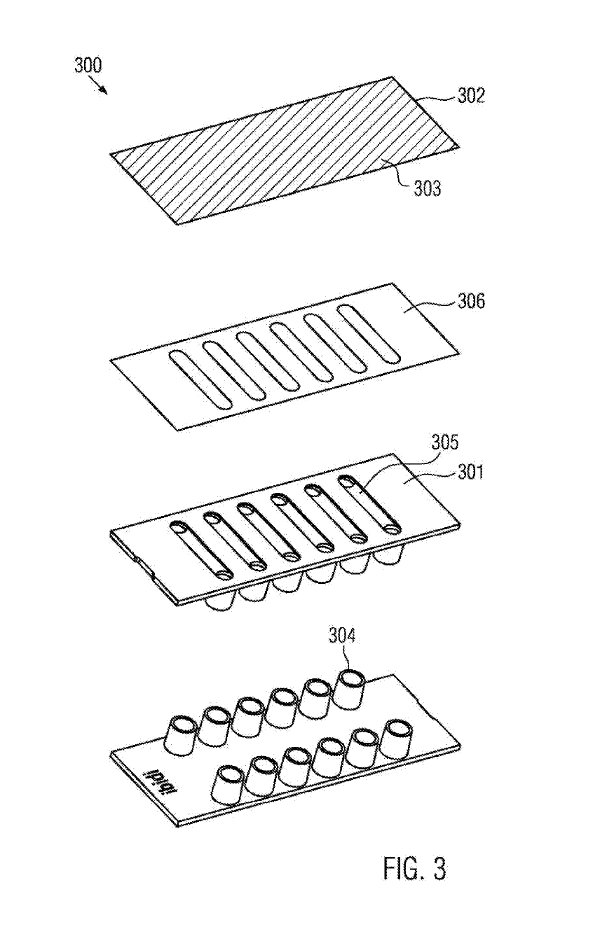

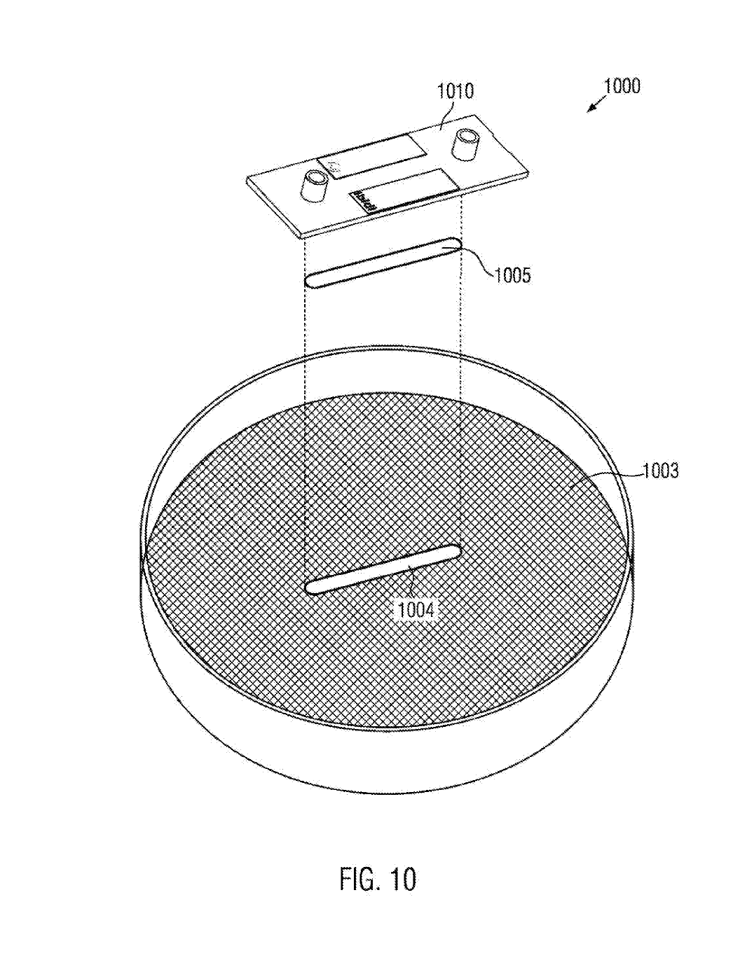

FIG. 3 schematically illustrates a further embodiment of an inventive sample chamber 300 in exploded view. In particular, the sample chamber 300 comprises a plurality of sample reservoirs 305 in the form of a channel. In this case, the first part 301 has the shape of bottom-less channel structures with extensions in the form of hollow cylinders. The second part 302 has the shape of a rectangular plate and may be coated with an oligomer and/or polymer layer 303. The coating may correspond to the coating 103 of the embodiment shown in FIG. 10 or may be any other coating type as previously discussed. The two parts may be connected to each other via a connecting layer 306. The connection may be established by glueing by means of a bonding agent or may be established by chemical or thermal merging. Also, the parts may be connected via a adhesion-promoting third part (not shown). Access to the individual sample reservoirs 305 may be accomplished in this embodiment, for instance by Luer connectors 304.

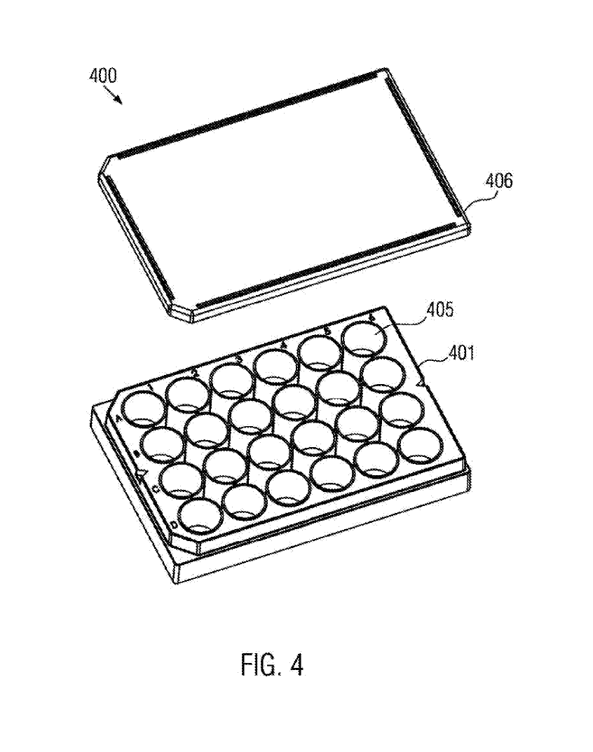

FIG. 4 schematically illustrates a further embodiment of an inventive sample chamber 400. In particular, the sample chamber 400 comprises a plurality of sample reservoirs 405. In this case, the first part 401 has the form of bottom-less reservoirs. The second part may have the form of a rectangular plate and may be coated with an oligomer and/or polymer layer (not shown). The coating may correspond to the coating 103 of the embodiment shown in FIG. 1 or may be any other coating type as previously discussed. The two parts may be connected to each other via a connecting layer. The connection may be established by glueing by means of a bonding agent or by chemical or thermal merging. Also, the parts may be connected by means of a adhesion-promoting third part (not shown). In order to prevent evaporation or contamination of the culture medium the sample reservoirs may be sealed by means of a capping construction 406.

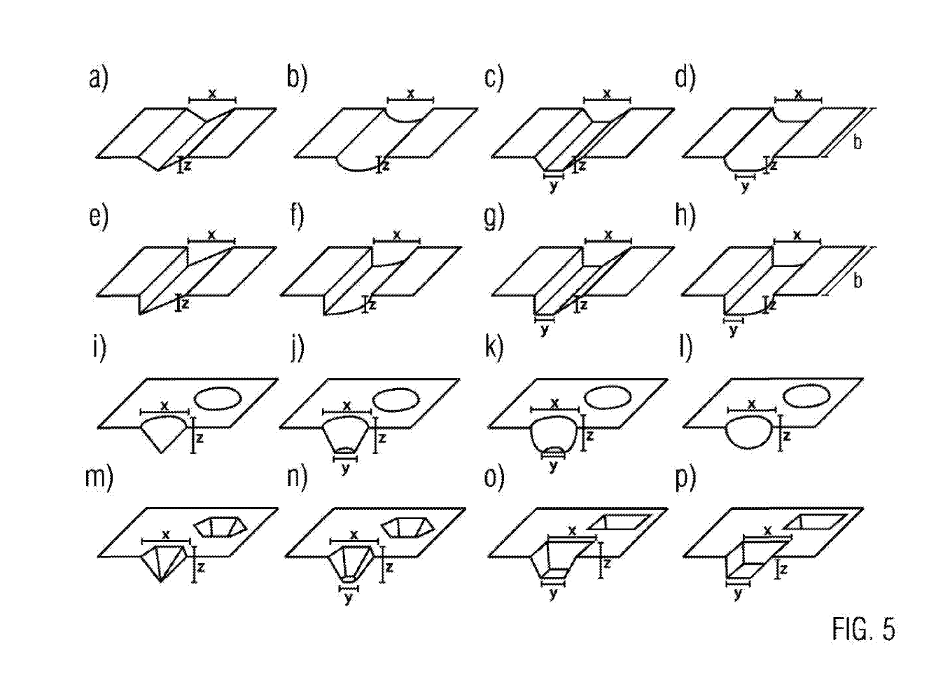

FIG. 5 schematically illustrates possible configurations for recesses, in particular of the coating, which are advantageous for fixing the cells or cell aggregates. The coating may correspond to the coating 103 of the embodiment illustrated in FIG. 1 or may be any other coating type as previously discussed. The recesses may have the configuration of channels, as shown in FIG. 5a-FIG. 5h, or cavities, as shown in FIG. 5i-FIG. 5p. The recesses may have a depth z of 50-2000 μm. The channels may have a width from 50 μm up to the width of the sample reservoirs at most. The channels and cavities shown may have a diameter and an edge length, respectively, x from 50 μm to 2000 μm. They may converge in an acute angle or in a rounded manner. They may extend in an acute angle, however, they may comprise a flat tip, as shown in FIGS. 5c, 5d, 5g, 5h, 5j, 5k, 5n 5o and 5p. The flat portion may have a width y of 10 μm to 300 μm. The micro recesses may have, as shown in FIG. 5a-FIG. 5d as well as in FIG. 5i-FIG. 5o, a symmetric configuration. In other cases, they may have, as shown in FIGS. 5d to 5h as well as in FIG. 5p, a non-symmetric configuration. The latter configurations are, for instance, suited for using the recesses as negative flow traps, in which cells are retained in flow experiments along the flow direction due to gravity and the recesses.

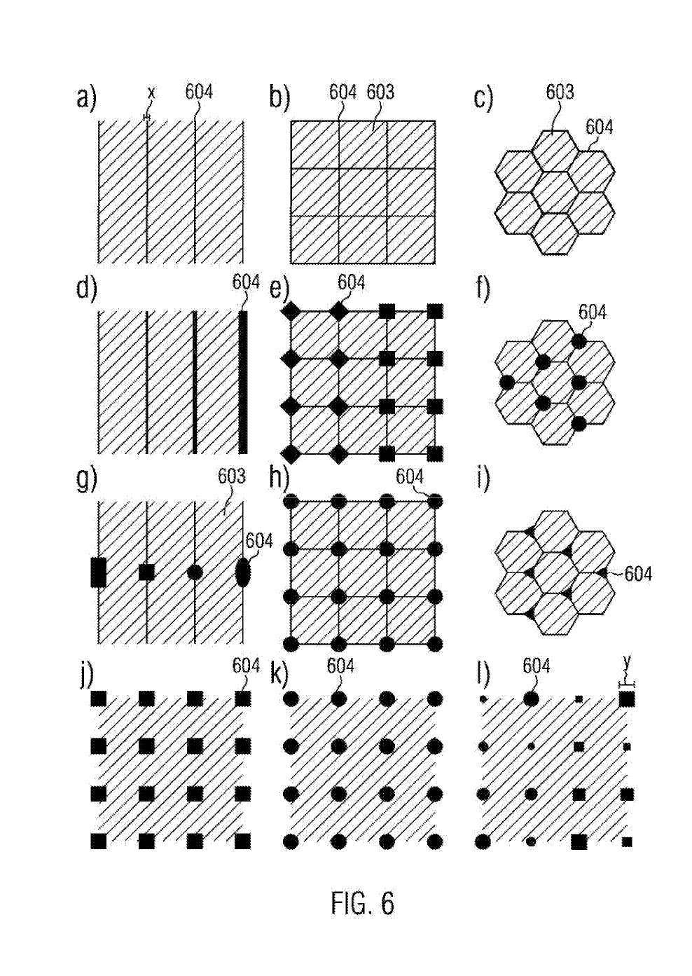

FIG. 6 schematically illustrates potential patterns, which are formed by cell adhesion regions in an inventive manner. Hatched regions 603 represent in this case oligomer and/or polymer coated regions, while non-coated regions 604, illustrated in black for better visibility, allow adsorption of biomolecules and cell adhesion. The coating may correspond to the coating 103 of the embodiment shown in FIG. 1 or may be any other of the coating types previously discussed. For such patterns respective distances x<1 μm are possible. The general structures in the form of lines and grids, as shown in FIGS. 6a-6c, are advantageous, for instance for the formation of cell aggregates, as well as localization, cell migration and cell interaction studies, for instance for neurons. Furthermore, round or polygonal faces with a diameter y of 5 μm-2000 μm, for example for cell separation or cell aggregation, are possible, as shown in FIG. 6j-FIG. 6l. Furthermore, mixed forms of faces, lines and grids are possible, as shown in FIG. 6o-FIG. 6i.

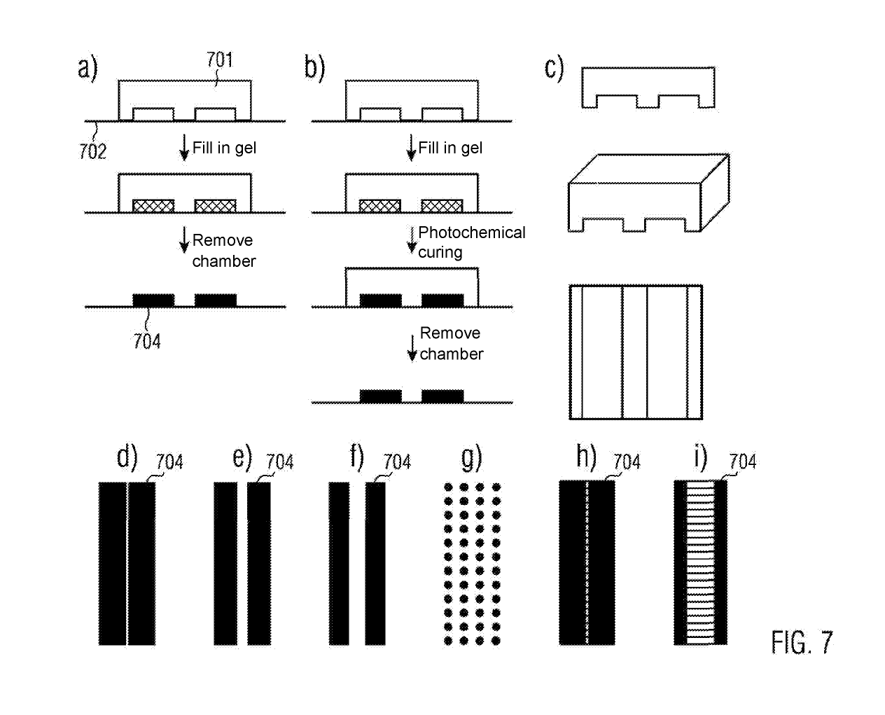

One option for structuring the oligomer or polymer layer is shown in FIG. 7, wherein the second part is connected to a corresponding three-dimensionally structured PDMS stamp negative. Molecule, oligomer or polymer solutions are drawn into the channel structures, formed by the stamp and the second part, between the second part and the stamp, by capillary effects, and thus bonding is established in the channel structures only. Alternatively or additionally the stamp may remain in contact with the second part during the cross-linking, thereby ensuring that the molecule, oligomer or polymer solution is cross-linked in the channel structures only. The coating may correspond to the coating 103 of the embodiment shown in FIG. 1 or may be any other of the coating types previously discussed.

FIGS. 7a and 7b illustrate a stamp 701 that is in contact with the planar face of a second part 702. It is illustrated how a molecule, oligomer or polymer solution for a hydrogel 703 is filled into the channels that are formed by the stamp 701 and the second part 702. FIG. 7a illustrates a use case, in which the molecule, oligomer or polymer solution or the hydrogel 703 is thermally, and enzymatically or wet-chemically cross-linked and secured so as to form an oligomer and/or polymer layer. FIG. 7b illustrates an example, in which the cross-linking and curing is accomplished by a photochemical process.

One of the methods illustrated in FIGS. 7a to 7c may also be used for the structuring of a hydrogel additionally introduced into the sample chamber, wherein cells may be embedded into the hydrogel.

FIG. 7c shows an illustrative stamp in cross-sectional, diagonal and top view.

FIG. 7d to FIG. 7i show illustrative structures that may be formed by means of such a stamp. For example, such structures are advantageous for migration and cell interaction assays, such as wound treatment assays with defined migration or interaction distances. In this case, FIGS. 7d to 7g illustrate structures from a hydrogel 703, in which cells may be embedded, for which no interaction paths exist, that is, the hydrogel structures do not have mutual connections. On the other hand, in the structures shown in FIGS. 7h and 7i interaction paths from hydrogel exist.

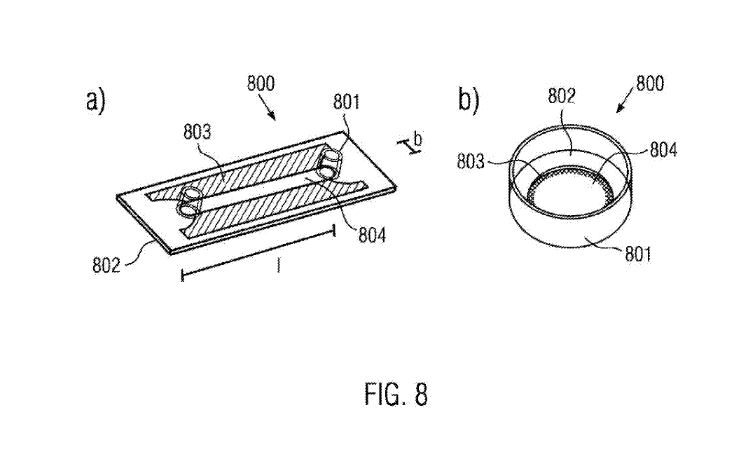

FIG. 8a schematically illustrates a further embodiment of an inventive sample chamber 810 in diagonal view. The sample chamber 800 comprises a first part 801 and a second part 802. In this case, the first part 801 has the configuration of a bottom-less channel with extensions in the form of hollow cylinders, wherein the channel has a length 1 and a width b. The second part 802 has the shape of a round plate and is provided with a cell- and/or biomolecule-rejecting coating 803 that surrounds an adhesion face 804. The coating may correspond to the coating 103 of the embodiment shown in FIG. 1 or may be any other of the coating types as previously discussed.

FIG. 8b schematically illustrates a further embodiment of an inventive sample chamber 810 in diagonal view. The sample chamber 800 comprises a first part 801 and a second part 802. In this case, the first part 801 has the configuration of a circular reservoir comprising through-hole or penetrating opening in the bottom. In particular, the through-hole or penetrating opening may comprise the total bottom face of the reservoir. The second part 802 has the shape of a round plate and is provided with a cell and/or pile molecule rejecting coating 803 that surrounds an adhesion face 804. In this case, the size of the adhesion face 804 may be freely selected during the fabrication. In this manner, the ratio of the media volume to the cell growth area may be adjusted. The first part 801 and the second part 802 may, for instance, correspond to the first part 101 and the second part 102 of the embodiment shown in FIG. 1.

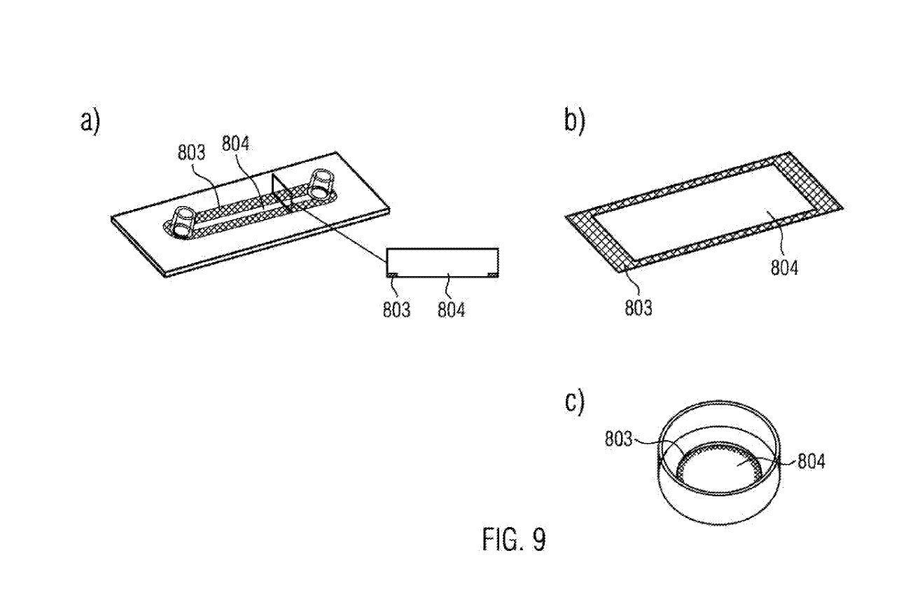

FIG. 9a schematically illustrates a modification of an embodiment of an inventive sample chamber as shown in FIG. 8a. In this case, the coating 803 is structured so as to form a cell- and/or biomolecule-rejecting frame between the walls of the sample reservoir and the adhesion face 804. This is shown in the cross-sectional view that illustrates a section through the channel of the sample chamber. In particular, this frame has a width in the range of 1 μm to 100 μm.

FIG. 9b illustrates a view of the second part of an inventive sample chamber including an illustrative coating 803 and an adhesion region 804. The second part may, for instance, correspond to the second part 802 of the embodiment as shown in FIG. 8. It is evident that the coating 803 forms a frame around the adhesion region 804. In particular, this frame has a width in the range of 1 μm to 100 μm.

FIG. 9c schematically illustrates a modification of the embodiment of an inventive sample chamber as shown in FIG. 8b. Corresponding to the modification as shown in FIG. 9a, also in this case, the coating 803 forms a cell- and/or biomolecule-rejecting frame between the walls of the sample reservoir and the adhesion face 804. In particular, the frame has a width in the range of 1 μm to 100 μm.

FIG. 10 schematically illustrates the structure of an inventive sample chamber 1000 in diagonal view. In this case, the sample chamber 1000 has the configuration of a reservoir that is open at the top. A cell- and/or biomolecule-rejecting coating 1003 is arranged on the bottom of the sample chamber, wherein the coating surrounds and region 1004. The coating may correspond to the coating 103 of the embodiment as shown in FIG. 1 or may be any other of the coating types discussed above. In this case, the adhesion region 1004 is sized so as to correspond in its size and shape to the size and shape of the flow channel 1005 of the channel-like sample chamber 1010. In this manner, the cell adhesion and/or the growth of cells may be examined on the same surface in the sample chamber 1010 under flow conditions, and in the sample chamber 1010 without flow. For example, the sample chamber 1010 may correspond to the sample chamber 100 of the embodiment shown in FIG. 1, that is, it may comprise first and second parts that respectively correspond to the first part 101 and the second part 102. For example, the sample chamber 1010 may correspond to the sample chamber 800 of the embodiment as shown in FIG. 8a.

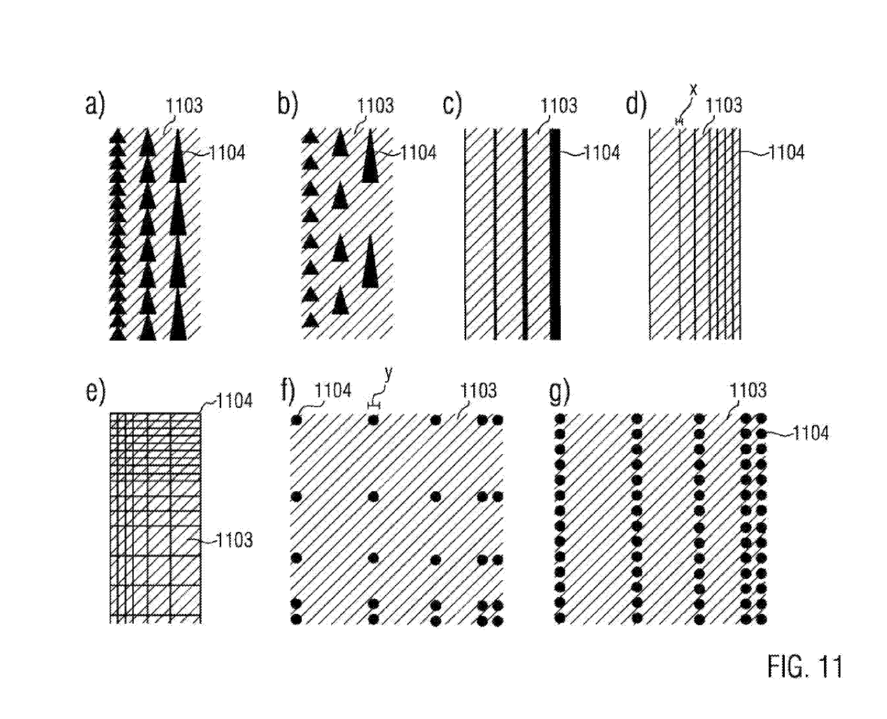

FIG. 11 schematically illustrates further optional patterns formed from cell adhesion regions in an inventive manner. In this case, hatched regions 1103 represent coated regions, while non-coated regions 1104, illustrated in black for better visibility, provide for adsorption of biomolecules and cell adhesion. The coating may correspond to the coating 103 of the embodiment as shown in FIG. 1 or may be one of the coating types as previously discussed. In particular, the distances x of such patterns may be less than or equal to 1 μm. FIGS. 11c to 11e illustrate patterns in the form of lines and grids which, for instance, are appropriate for the generation of cell aggregates and their localization, cell migration and cell interaction studies, for instance for neurons.

FIG. 11a, 11b, 11f and 11g illustrate patterns of round or polygonal areas having a diameter y of 5 μm-2000 μm. These are, for instance, appropriate for cell separation, cell migration or cell aggregation. The structures as shown in FIGS. 11a and 11b that comprise a plurality of triangular areas of different sizes are particularly suited to affect cell migration and cell interaction.

Mixed configurations of the patterns as shown in FIG. 11 are also an option.

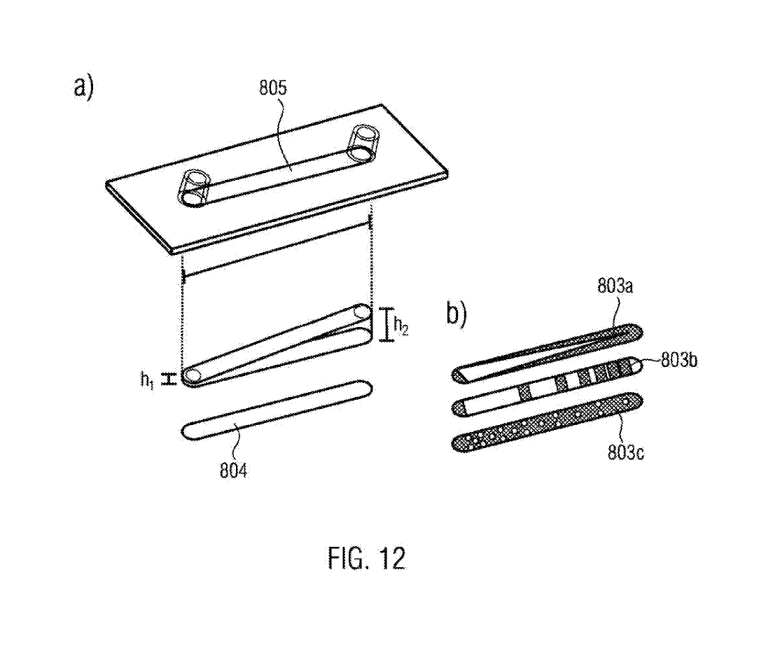

FIG. 12 schematically illustrates a modification of the embodiment of an inventive sample chamber as shown in FIG. 8a. In this case, the coating 803 comprises a pattern 803a, 803b, 803c so as to homogeneously distribute the cell concentration within the sample reservoir 805. FIG. 12 additionally illustrates that the height of the reservoir 805 changes along the channel, wherein the following holds: h₁≤h≤h₂ or h₂≤h≤h₁. In this manner, the shear tension acting on the adhering cells may be varied during flow operation mode. It is advantageous to select a pattern 803a, 803b or 803c such that the total size of the available adhesion area is inversely proportional to the height of the sample reservoir in order to obtain a constant cell concentration along the channel.

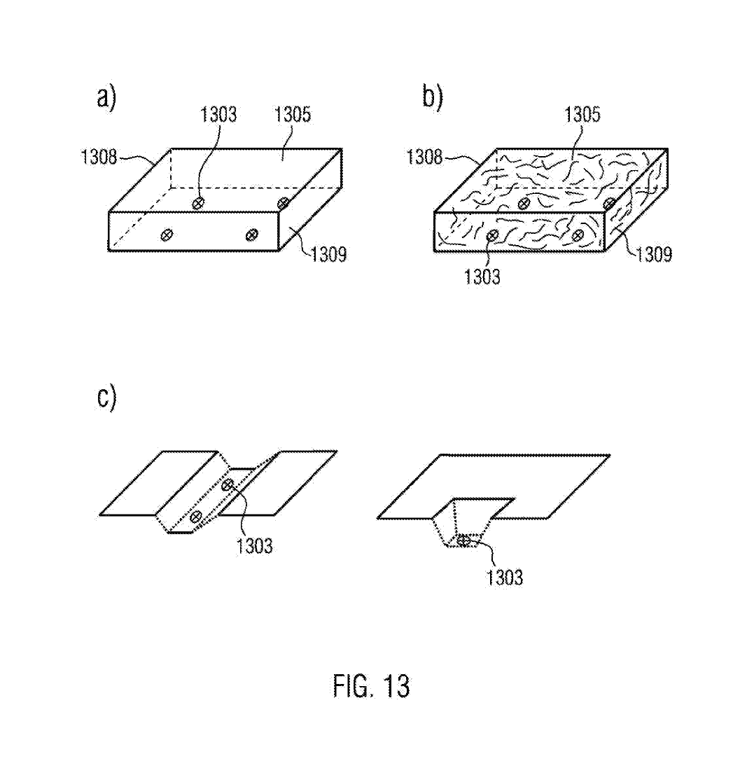

FIG. 13a schematically illustrates an arrangement of adhesion regions or functionalized regions 1303 in a sample reservoir 1305. Furthermore, FIG. 13b illustrates that the sample reservoir 1305 is additionally filled with natural or synthetic hydrogel, in which cells may be embedded. This is indicated by the irregular lines. A flow or concentration gradient may exist between the faces 1308 and 1309. FIGS. 13c and 13d schematically illustrate the arrangement of functionalized regions 1303 in recesses of the coating. The coating may correspond to the coating 103 of the embodiment as shown in FIG. 14 or may be any other of the coating types as discussed above. In particular the recesses as shown may correspond in shape and dimensions to the recesses as illustrated in FIG. 5.

FIG. 14 schematically illustrates further potential patterns, which may be formed from cell adhesion regions in an inventive manner. In this case, dotted regions represent coated regions. Uncoated regions, represented in black for better visibility, allow adsorption of biomolecules and cell adhesion. The coating may correspond to the coating 103 of the embodiment as shown in FIG. 1 or may be any other of coating types as previously discussed. In particular, FIG. 14 illustrates coating patterns in channel structures that allow the establishing of pressure and/or concentration gradients in the sample reservoir. In this case the gradient extends along the direction of the arrow in the Figure. It is possible to apply the coating 1403 so as to form adhesion regions, as shown in FIG. 14a, or migration lines and grids having distances x≤1 μm, as shown in FIG. 14b, in addition to the gradient structure. Similarly, microstructures in the form of lines and grids are conceivable. Also, a combination of the patterns and structures as illustrated in FIGS. 14a and 14b is an option.

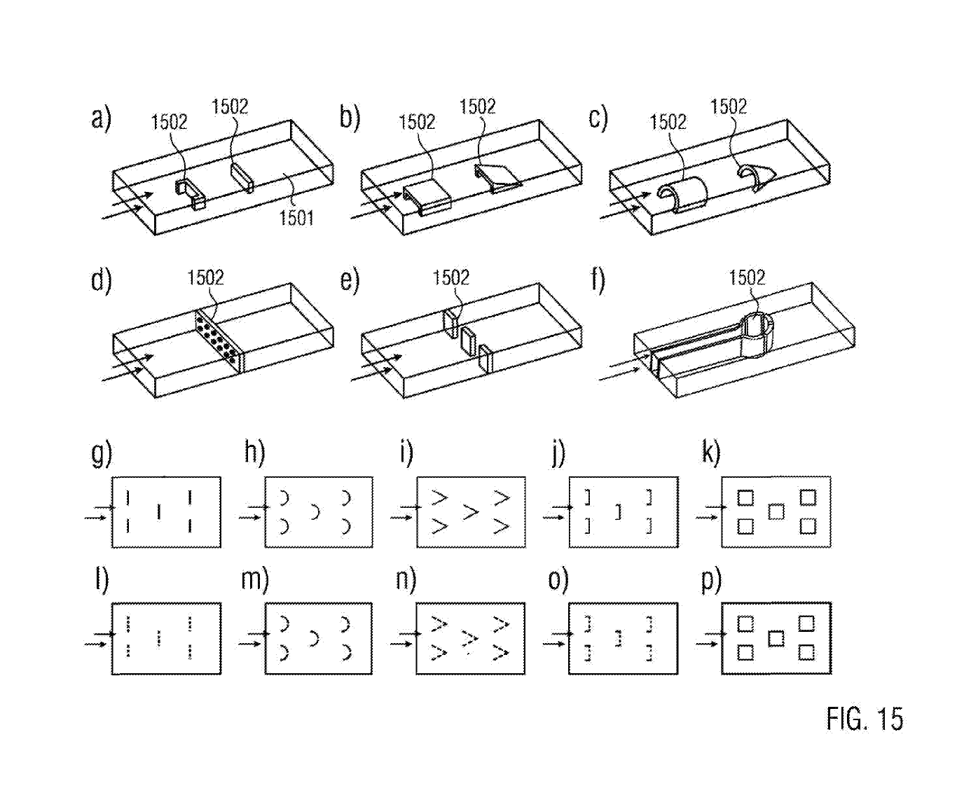

FIG. 15a to 15f schematically illustrate modifications of an embodiment of an inventive sample chamber in diagonal view. In this case, a portion of the sample reservoir configured as a channel is illustrated having a bottom face 1501 that may be covered by a coating. The coating may correspond to the coating 103 of the embodiment as shown in FIG. 10 or may be any other of coating types as previously discussed. Moreover, the Figures illustrate elevations 1502 that are arranged on the bottom face 1501. It is evident that the elevations 1502 may take on different geometric shapes. For example, as shown in FIGS. 15a, 15d, 15e and 15f they may have a configuration of walls. In other cases, as shown in FIGS. 15b and 15c, they may have the configuration of half shells. In case a flow 1503 is taking place in the channel the elevations 1502 may act as flow traps, thereby fixing cells and/or cell aggregates.

The elevations 1502 may be arranged relative to each other in any way. The elevations 1502 may be coated or may be uncoated. The height of the elevations 1502 may be 10 μm-5000 μm. A space may exist between an upper edge of an elevation 1502 and the ceiling of the sample reservoir, as shown in FIGS. 15a to 15c. In other cases, the elevations 1502 may cover, as shown in FIGS. 15d to 15f, the total height of the channel. The elevations may have a width from 10 μm up to the width of the channel.

As shown in FIG. 15d, the elevations 1502 may comprise a penetrating opening or through-hole. In particular, the openings may have a diameter of less than 10 μm. This is advantageous for having the possibility of utilizing the flow and the channel in an effective manner or to use the elevations as “sieve”, through which only particles may pass that have a maximum size determined by the opening. In the modification shown in FIG. 15f, the illustrated elevations 1502 form an inner channel within the channel-like sample reservoir including a subsequent cylinder-like chamber. In this case, the inner channel and the chamber are connected to the remainder of the sample reservoir by means of openings in the modification as shown. Such an inner channel may have a length from 100 μm up to the total length of the sample reservoir. The chamber formed may have an inner diameter of 100 μm to 2000 μm. The openings may have an effective width of less than 10 μm.

FIGS. 15g to 15p illustrate further modifications and arrangements of the elevations 1502 in a top view. In this case, the dotted lines shown in FIGS. 151 to 15p indicate that through-holes are present within these elements, as discussed above.

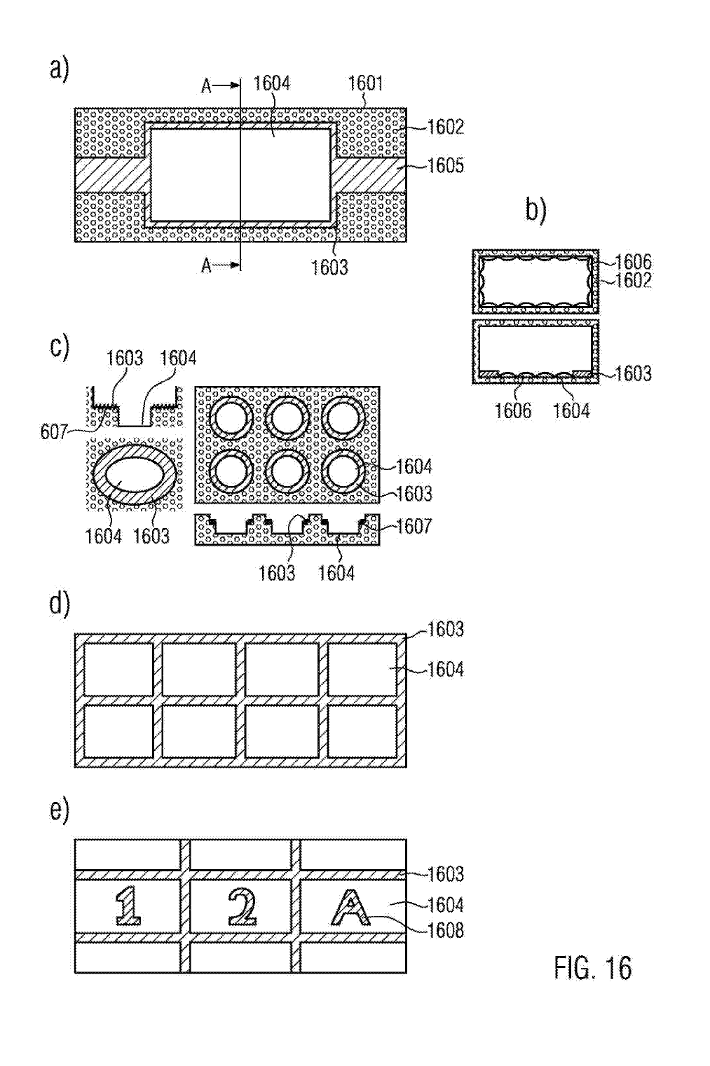

FIG. 16 schematically illustrates illustrative applications of inventive sample chambers.

FIG. 16a illustrates a sectional view through a channel-like sample reservoir 1601 as a top view. The sidewalls 1602 of the sample reservoir are visible. Hatched regions indicate regions of the sample reservoir 1601 that are provided with an inventive coating 1603. The coating may correspond to the coating 103 as shown in FIG. 14 or may be any other of the coating types as discussed above. It is evident that the coating 1603 covers the supply channels 1605 and additionally extends along the inner edge of the sidewalls 1602. In this case, the coating may have a width of 1 μm to 10 μm. In this manner, cell and biomolecule adhesion is suppressed in the supply channels and on the sidewalls and is restricted to the adhesion region 1604.

FIG. 16b illustrates in the lower part of the Figure a cut view along the line A-A′ through the sample reservoir 1601 in flow direction as shown in FIG. 16a. Additionally it is shown that cell growth 1606 occurs in the adhesion region 1604. It is evident that the coating 1603 suppresses cell growth on the sidewalls.

For comparison, the upper partial image of FIG. 16b illustrates a corresponding cut view through a sample reservoir having the same geometry, however, without a coating 1603. It is evident that cell growth 1606 occurs on each of the walls of the sample reservoir.

FIG. 16c schematically illustrates as cross-sectional view and top view reservoir structures having several steps. For example, the steps may be formed by graded recesses in the bottom face of the sample reservoir. In FIG. 16d it can be seen that the step faces 1607 are provided with an inventive coating 1603. In this way, the cell adhesion is restricted to the bottom regions 1604 of the reservoir structures.

FIG. 16d schematically illustrates a cut-out of an embodiment of an inventive sample reservoir in top view. It can be seen that the inventive coating 1603 forms grid structures. In this case, the coated regions may have a width of 1 μm to 1000 μm. In this manner, a plurality of adhesion regions 1604 is formed. This provides the possibility of a co-culture of different cell types or cell genotypes at identical growth conditions. FIG. 16e illustrates eight such adhesion regions, however, any number of adhesion regions 1604 may be provided.

FIG. 16e illustrates a modification of the embodiment as shown in FIG. 16d. An enlarged view of three adhesion regions 1604 with surrounding coating 1603 is shown. Furthermore, it is evident that the adhesion regions are provided with re-finding structures 1608. Such re-finding structures, as are used for correlated fluorescence and electron microscopy (CLEN), for instance, may be applied by etching, embossing or laser treatment in the bottom face of the sample reservoir, for example. It is evident that the coating 1603 may also be applied on the re-finding structures 1608. In this manner, a growth on the re-finding structures 1608 may be suppressed, thereby avoiding a loss of visibility thereof.

It is needless to say that the features referred to in the embodiments described above are not restricted to the specific combinations and they may optionally be used in any other combinations. Moreover, the geometry of the reservoir is not restricted to the shapes as shown in the Figures. Any other geometries are conceivable.

1. A sample chamber, comprising
a first part;
a second part connected to the first part; and
a sample reservoir delimited by the first part and second part; and
wherein at least one of the sidewalls and the ceiling of the sample reservoir are formed by the first part and the bottom of the sample reservoir is formed by the second part,
wherein the bottom of the sample reservoir comprises a planar face that includes a coating, and
wherein the coating is formed of at least one of an oligomer layer and a polymer layer, the at least one of an oligomer layer and a polymer layer being at least one of cell-rejecting and biomolecules-rejecting.

2. The sample chamber of claim 1, wherein
the first part has a configuration of a cover plate including a recess;
the second part has a configuration of a bottom plate; and
the sample reservoir is configured as a channel-like cavity which is formed by the recess in the cover plate in combination with the bottom plate.

3. The sample chamber of claim 1, wherein the planar face comprises at least one predetermined cell adhesion region that is not covered by the coating.

4. The sample chamber of claim 1, wherein the planar face comprises a plurality of at least one of cell adhesion regions and coating regions.

5. The sample chamber of claim 4, wherein at least one of a distance between neighboring cell adhesion regions and a size of the areas of neighboring cell adhesion regions changes monotonously, in particular strictly monotonously, along a linear direction.

6. The sample chamber of claim 1, wherein the coating comprises one or more locally restricted recesses, and wherein the coating comprises the bottom of the recesses.

7. The sample chamber of claim 1, wherein the coating has one or more of the following aspects:
a constant layer thickness of less than 1 μm, in particular of less than 500 nm; and
when comprising recesses formed by a variation of the layer thickness, the layer thickness outside the recesses having a constant layer thickness of less than 2000 μm, and within the recesses having a layer thickness of less than 1 μm, in particular less than 500 nm.

8. The sample chamber of claim 1, wherein the coating extends along and directly adjacent to a sidewall of the sample reservoir.

9. The sample chamber of claim 1, wherein the coating has one or more of the following aspects:
hydrophobic properties, and
not being toxic for cells.

10. The sample chamber of claim 1, wherein the coating comprises one or more of the following:
polyethers, polyols, polyamides, polymethacrylates, polyhydroxylmethyl methacrylates, polysaccharides, polyamines, polypeptides, wherein in particular the coating comprises polyvinyl alcohol, PVA.

11. The sample chamber of claim 1, wherein the surface of the coating comprises, in predetermined regions, at least one of molecules, oligomers and polymers capable of cell adhesion.

12. The sample chamber of claim 1, wherein the sample reservoir comprises at least one of an opening and a cavity, wherein the at least one of an opening and a cavity is formed by at least one of a through-hole and a recess in the first part.

13. The sample chamber of claim 1, wherein the second part is a two-dimensional element, and in particular the two-dimensional element has a thickness of 50 to 250 μm, preferably 100 to 200 μm.

14. The sample chamber of claim 1, wherein the second part comprises at least one of:
one or more elevations, and
one or more recesses,
wherein the at least one of one or more elevations and one or more recesses are covered by the coating.

15. The sample chamber of claim 1, wherein one or more of the following aspects are met:
at least one of the first part and the second part comprises at least one of a plastic and an elastomer; and
the second part comprises a glass.

16. A method of fabricating a sample chamber, in particular according to claim 1, comprising the steps of:
providing a first part;
providing a second part, the second part having a planar face;
coating the planar face with a layer of at least one of an oligomer and a polymer that is at least one of cell-rejecting and biomolecule-rejecting; and
connecting the first part to the second part so as to form a sample reservoir that is delimited by the first part and the second part, wherein at least one of the sidewalls and a ceiling of the sample reservoir is formed by the first part and a bottom of the sample reservoir is formed by the second part.

17. The method of fabricating a sample chamber of claim 16, wherein coating the planar face comprises structuring the coating by means of a shaping stamp.

18. The method of fabricating a sample chamber of claim 16, wherein providing the second part comprises extruding the second part, and coating the second part comprises co-extruding a polymer layer together with the second part.
